(19) United States
(12) Patent Application Publication
(10) Pub. No.: US 2016/0314567 A1
(43) Pub. Date: Oct. 27, 2016

(54) SYSTEMS AND METHODS FOR IMAGE/VIDEO RECOLORING, COLOR STANDARDIZATION, AND MULTIMEDIA ANALYTICS

(71) Applicant: The Board of Regents of The University of Texas System, Austin, TX (US)

(72) Inventors: Sos Agaian, San Antonio, TX (US); Clara Mosquera-Lopez, San Antonio, TX (US)

(21) Appl. No.: 15/082,036

(22) Filed: Mar. 28, 2016

Related U.S. Application Data
(60) Provisional application No. 62/138,696, filed on Mar. 26, 2015.

(51) Int. Cl. G06T 5/40; G06T 7/40

(52) U.S. Cl. CPC G06T 5/40; G06T 7/408; G06T 2207/10004

(57) ABSTRACT

The present invention provides systems and methods for image recoloring and color standardization. The invention relates, in part, to standardization of digitized whole-slide histopathology images and digitized images of tissue microarrays (TMA). Various aspects of the invention are directed to the detection of color feature points from 3D histogram of a reference image (considered a well-stained image) and the region-based transference of color statistics between a reference image and a target image (image to be standardize). Another aspect of the present invention is an image/video colorfulness measure. A further aspect of the invention includes multimedia analytics application, including a retrieval application. Another aspect of the invention is directed to on-line viewing and recoloring of images, including but not limited to face and clothing.

### PRIORITY CLAIM

This application claims priority to U.S. Provisional Application Ser. No. 62/138,696 entitled “SYSTEMS AND METHODS FOR IMAGE/VIDEO RECOLORING, COLOR STANDARDIZATION, AND MULTIMEDIA ANLYTICS” filed Mar. 26, 2015, which is incorporated herein by reference in its entirety.

### BACKGROUND OF THE INVENTION

1. Field of the Invention

The invention relates generally to the image color processing and measurements recoloring, and standardization. Particularly, this invention is directed to color standardization of digitized histopathology and recoloring of faces, clothes, landscapes, etc. More specifically, it includes (a) systems and methods for locally transferring color from a reference well-stained histopathology image to one or more histopathology images, such that they can be further analyzed and compared by automated computerized diagnosis systems; (b) to improvements in quality assurance for pathology using digital microscopy; (c) to system and methods for application e-commerce, including recoloring face, clothing, and other kinds of images; and (d) systems and methods for application image and/or video analytics, including image retrieval.

2. Description of the Relevant Art

Color standardization of histopathology plays an important role in image analysis because the performance of the classification may be adversely affected by color variations. Color variations are caused by variations in staining and scanning conditions due to image acquisition protocols, capturing-device properties, and lighting conditions. Color nonstandardness (i.e., the notion that different image regions corresponding to the same tissue will occupy different ranges in the color spectrum) is one of the most important issues in whole-slide imaging technologies, particularly since even subtle variations of color appearance might cause image misinterpretation by pathologists or computerized decision support systems. Two aspects have made the standardization of color a challenging problem: the presence of important, but subtle, diagnostically important details in color images, and the heterogeneity of tissue composition. Several approaches to histopathology color standardization have been proposed. However, none of the approaches have used a quality metric to evaluate the performance of the standardization algorithm being used and its impact on the overall quality of the image.

Although several studies have been carried out to develop algorithms for color image standardization, various researchers in the field of computer-aided diagnosis of (CAD of PCa) only used color model transformations for image normalization. For instance, Red Blue Green (RGB) to Hue Saturation Intensity (HSI) transformation in order to confine color variations to the intensity channel of the HSI color space instead of affecting all three RGB channels Other perceptual color models such as CIELAB can be also used for normalizing color images.

Color standardized images can be then quantitative analyzed and fairly compared to images from different laboratories and scanned using different whole-slide imaging (WSI) technologies.

A particular application of the invention is directed to online apparel shopping involving a color matching scheme using color codes provided with images to be merged. For example, on-line viewing of one article, such as clothing, on another structure, including creating an item from image-data corresponding to a colored article selected by an on-line viewer from an on-line viewer site with an image of a color structure selected by the on-line viewer, and indicating whether the colored article and the colored structure satisfy a color-matching criterion. The consumer in today's market is limited to a particular retailer's or department store's inventory, selection and styles. Recent technological advances have attempted to enhance the shopping ability through the use of e-commerce, referred to as “online shopping.” There is, therefore, a commercial need for better measurement and recoloring technology.

### SUMMARY OF THE INVENTION

The present invention discloses a system and methods for standardizing the color of digitized histopathology slides based on local transference of color statistics between a reference well-stained image and a target image. Color standardization is a necessary preprocessing step prior to image description and quantitative analysis.

In one embodiment, the present invention provides a method for detecting the predominant colors of a histopathology slide or region of interest. Those feature colors are selected via 3D color histogram maxima detection. The membership of the pixel of the reference and target images is determined by minimizing a distance metric, for example Euclidean distance. It is important to know that the disclosed method reference cluster membership of pixels in the reference and target images to the selected reference color features.

Another embodiment of the inventions refers to the mechanism for transferring color statistics. This method computes the mean (or alpha-trimmed mean) and standard deviation for each cluster referenced to color feature points in order to transfer statistics of color channel independently between the reference and target images. Local color transference is an additive linear function and the amount of transference between specific image regions is modulated by a fuzzy membership coefficient.

The methods of the present invention successfully standardize the color of histopathology images while preserving important diagnostic details and structural information of the image.

The methods of the present invention may be incorporated into other schemes, for example, Systems and Methods for Quantative Analysis of Whole-Slide Histopathology Images Using Multi-Classifier Ensemble Schemes, by Sos S. Agaian, Clara M. Mosquera-Lopez and Aaron Greenblatt, Application No. PCT/US14/60178, herein incorporated by reference. Also herein incorporated by reference is Clara Mosquera-Lopez and Sos Agaian, Color Standardization of Digitized Histopathology Using Fuzzy Association of Nonstandardized Pixels with Reference 3D Color Histogram Feature Points (submitted to IEEE TRANS. ON BIOMEDICAL ENG. 2015).

### BRIEF DESCRIPTION OF THE DRAWINGS

Advantages of the present invention will become apparent to those skilled in the art with the benefit of the following detailed description of embodiments and upon reference to the accompanying drawings in which:

FIG. 1 presents the flow diagram of the disclosed system and methods;

FIG. 2 shows an illustrative example of the detected histogram feature points;

FIG. 3 illustrates the results of segmenting a reference image according to the nearest neighbor dominant color;

FIG. 4 presents the result of image standardization using the disclosed methods;

FIG. 5 shows a flow diagram of a method for color standardization using stored reference images;

FIG. 6 presents an example of face color modification using fuzzy color transference;

FIG. 7 shows the colorfulness measure for several prostate cancer histopathology images;

FIG. 8 shows the colorfulness measure for several flowers images;

FIG. 9 shows the colorfulness measure for several plain color patches; and

FIG. 10 shows the colorfulness measure for prostate cancer histopathology images of different grades (Gleason grade 3, 4, and 5).

While the invention may be susceptible to various modifications and alternative forms, specific embodiments thereof are shown by way of example in the drawings and will herein be described in detail. The drawings may not be to scale. It should be understood, however, that the drawings and detailed description thereto are not intended to limit the invention to the particular form disclosed, but to the contrary, the intention is to cover all modifications, equivalents, and alternatives falling within the spirit and scope of the present invention as defined by the appended claims.

### DETAILED DESCRIPTION OF THE PREFERRED EMBODIMENTS

It is to be understood the present invention is not limited to particular devices or methods, which may, of course, vary. It is also to be understood that the terminology used herein is for the purpose of describing particular embodiments only, and is not intended to be limiting. As used in this specification and the appended claims, the singular forms “a”, “an”, and “the” include singular and plural referents unless the content clearly dictates otherwise. Furthermore, the word “may” is used throughout this application in a permissive sense (i.e., having the potential to, being able to), not in a mandatory sense (i.e., must). The term “include,” and derivations thereof, mean “including, but not limited to.” The term “coupled” means directly or indirectly connected.

### Local Color Correction and Recoloring in Whole-Slide Histopathology Images Using 3d Color Histogram Reference Feature Points

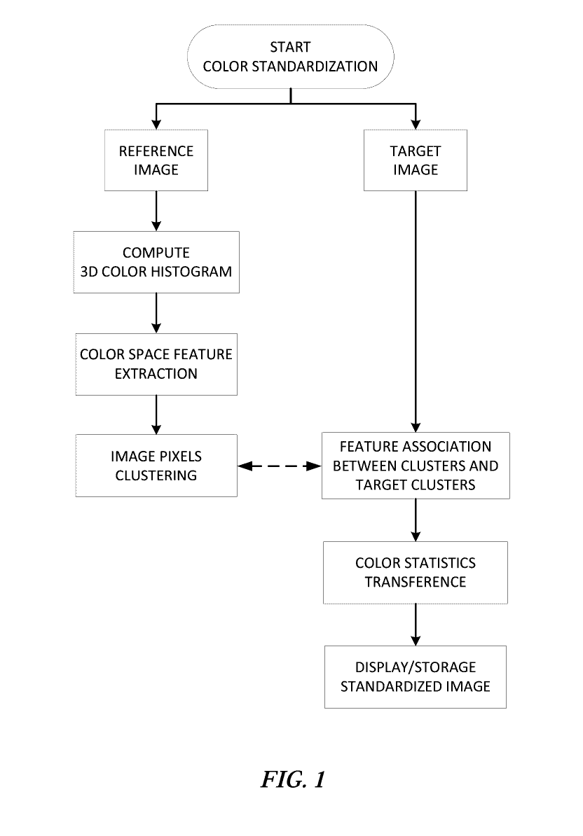

This disclosure provides a system and methods for color standardization of biopsy images, such that tissue structures are colored in the same way, regardless the source of the tissue and the complexity of the tissue structures. The local color normalization approach disclosed here is designed to process the color of an input image or target image Iₜ according to a reference image Iᵣ; Iₜ has a desired color distribution for a given application. For example, this preprocessing system can be used prior to feature extraction and classification in computer-aided diagnosis systems for cancerous regions from whole-slide histopathology. The system comprises 3 general blocks as illustrates in FIG. 1: (1) 3D color histogram feature points, (2) image pixels clustering, and (3) statistics calculation and transference.

Consider an image I={f (i, j, k)|1≦i≦H, 1≦j≦W, kε{r, g, b}}, of size H×W pixels and each pixel iₚ is composed by 3 color components, for example {r, g, b } or components corresponding to any other suitable color space. For the specific case of a RGB color model, each channel of the image may have pixel components with intensity levels in the interval [0, 255]. Then, the 3D color histogram of Iᵣ can be computed as follows:

$$h ( r , g , b ) = {\sum }_{p = 1}^{H \times W} {1}_{{i}_{p} = \{ r , g , b \}} ( {i}_{p} ) \qquad Equation 1$$

Next an iterative process is performed to find relevant local maxima in the histogram. Those more frequent points are considered histograms features and they are somehow related to important tissue structures. Initial local maxima candidates are detected using a non-overlapping sliding window of size s×s×s. A histogram point h(r,g,b) is considered a maximum if all the other pixels within the window have lower frequency.

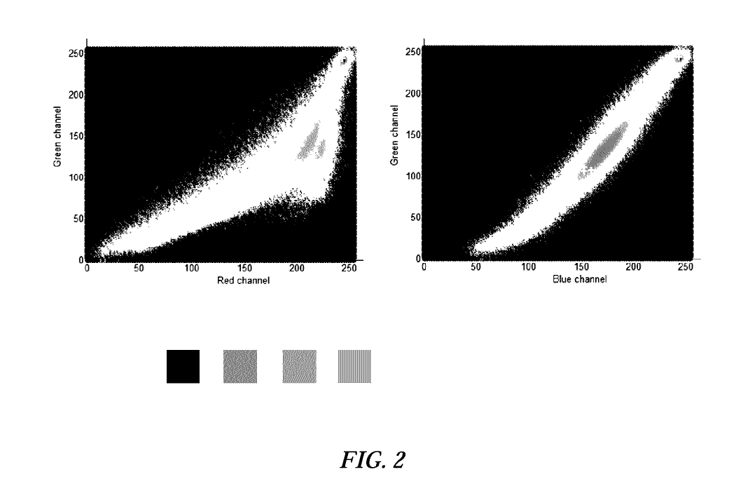

Once initial maxima are detected, the histogram is repeatedly filtered using Gaussian filters with varying standard deviations to construct histograms scales; only the maxima points are kept after filtering. The number of scales produced by iteratively filtering the 3D color histogram can be adjusted according to the application and the expected results. The final maxima points are called histogram features and examples of histogram features for Hematoxylin and Eosin stained prostate cancer tissue samples are shown in FIG. 2.

In another embodiment, the invention provides a method for grouping image pixels using the detected histogram features. First, hard clusters are defined in the reference image I by minimizing a distance metric such as the Euclidean distance between each pixel and all possible feature points. This process results in labeling each pixel in the reference image. On the other hand, the pixels in the target are grouped using a fuzzy membership which will be used later to modulate the amount of color transference. The membership index is computed using the following equation:

$${u}_{pj} = \frac{1}{{\sum }_{l} {( \frac{‖ {i}_{p} - {fp}_{j} ‖}{‖ {i}_{p} - {fp}_{l} ‖} )}^{\frac{2}{m - 1}}} \qquad Equation 2$$

In the above equation, fp are feature points and m is a real constant used to indicate the fuzziness of the clustering procedure.

In the target image Iₜ, each pixel is assigned to the cluster with the maximum membership index in order to computer cluster statistics. Once the cluster statistics are calculated in both Iᵣ and Iₜ the transference of color statistics are transferred at a pixel basis between color channels independently using the following equation:

$${i}_{p , new} = {\sum }_{fp} {u}_{p , fp} ( {μ}_{r , fp} + \frac{{σ}_{r , fp}}{{σ}_{t , reg}} ( {i}_{p} - {μ}_{t , reg} ) ) \qquad Equation 3$$

In equation 3, u_{p,fp} is the membership index of the pixel p to the group identified by the feature point fp; the subscripts r,t represent the reference and target statistics, respectively. The color transference procedure can be done using a suitable color model. In case a target image is transformed before statistics transference, it must be converted back to an RGB color model.

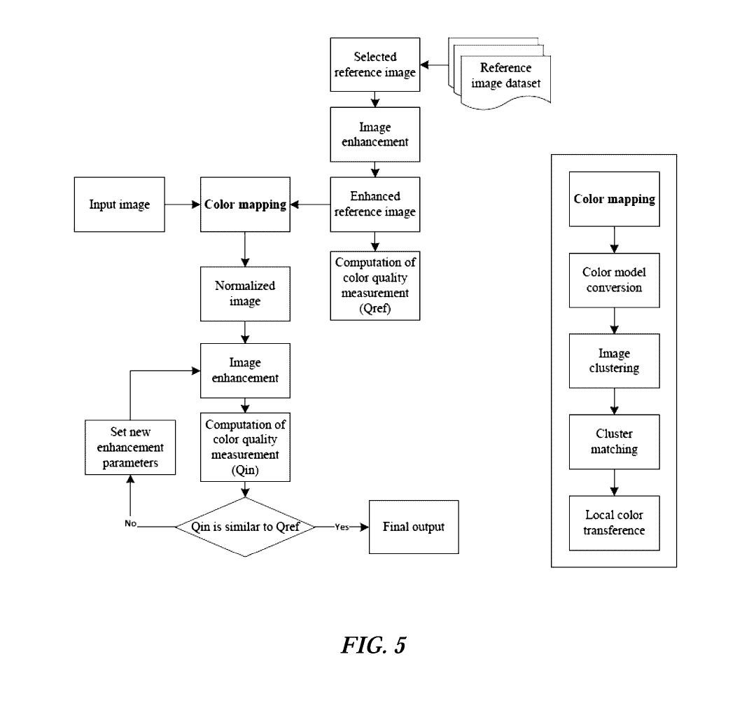

In another embodiment, fuzzy local color standardization is provided. The fuzzy local color standardization approach disclosed here is designed to alter the color of an input image Iᵢ(x, y) according to a reference image Iᵣ(x, y); Iᵣ(x, y) has a desired color distribution for a given application. The method comprises 5 general steps as illustrated in FIG. 5: (1) color model conversion of reference and input images from RGB to a decorrelated color model; (2) images' pixels clustering; (3) pixel matching; (4) local color transference based on membership grade of pixels to a given cluster; and (5) conversion of pixels back to the original RGB color model in order to obtain the normalized output image.

Pixels clustering can be performed using any fuzzy clustering algorithm. For example the fuzzy c-means may be employed. Fuzzy c-means is an iterative optimization method, which updates the degree of membership indexes and the cluster centroids as follows:

In the initialization step of the algorithm, the number of desired clusters C and fuzzification parameter are defined. At this step random selection of cluster centroids

$${c}_{j}^{( 0 )}$$

is performed and initial membership indexes are computed

$${u}_{ij}^{( 0 )} .$$

For each iteration k, the cluster centroids are computed using the following equation:

$${c}_{j}^{( k + 1 )} = \frac{{\sum }_{i = 1}^{S} {( {u}_{ij}^{( k )} )}^{m} {x}_{i}}{{\sum }_{i = 1}^{S} {( {u}_{ij}^{( k )} )}^{m}} \qquad Equation 4$$

where m is a real number greater than 1 (m >1) corresponding to the fuzzification parameter, uᵢⱼ is the degree of membership of

$${x}_{i} ∈ {R}^{N}$$

in the cluster j, and

$${c}_{j} ∈ {R}^{N}$$

is the center of the cluster.

Next, the membership indexes for each pixel of the image is updated according to the following expression:

$${u}_{ij}^{( k + 1 )} = \frac{1}{{\sum }_{l = 1}^{C} {( \frac{‖ {x}_{i} - {c}_{j}^{( k + 1 )} ‖}{‖ {x}_{i} - {c}_{l}^{( k + 1 )} ‖} )}^{\frac{2}{m - 1}}} \qquad Equation 5$$

Cluster centroids and membership indexes are updated iteratively until one of the stop criteria is reached:

$$‖ {u}_{ij}^{( k + 1 )} - {u}_{ij}^{( k )} ‖ < ɛ ∈ ( 0 , 1 )$$

or k=K , where K is a predefined maximum number of iterations and ε is a real number.
Once the clusters have been defined for the reference and input image, they are matched using a distance measure between centroids. Color transference is performed by local transference of color statistics between corresponding clusters. The color transference function may be linear or non-linear and the influence of the transformation is controlled by the membership grade of each pixel to a given cluster. For example, the following linear function may be employed for color transference:

$${I}_{i}^{norm , ch} ( x , y ) = {I}_{i}^{ch} ( x , y ) + {u}_{( x , y ) j} ( ( α - {μ}_{Ir , j}^{ch} ) + \frac{{σ}_{Ir , j}^{ch}}{{σ}_{Ii , j}^{ch}} ( {I}_{i}^{ch} ( x , y ) - ( α - {μ}_{Ii , j}^{ch} ) ) - {I}_{i}^{ch} ( x , y ) ) \qquad Equation 6$$

As can be seen from the equation above, if a pixel has a strong association to the j^{th} cluster, u_{(x,y)j} will be close to 1 and the pixel will be transformed. If the pixel is not a member of the j^{th} cluster, u_{(x,y)j} will tend to zero and the pixel will remain practically unmodified. In Equation 3,

$$( α - {μ}_{Ij}^{ch} )$$

is the alpha-trimmed mean of the pixels belonging to the j^{th} cluster in the channel ch, and

$${σ}_{Ij}^{ch}$$

is their standard deviation.

### Optimal Image and Video Standardization

This embodiment of the invention discloses a method for adjusting the parameters of a color standardization method. This method is suitable for any parametric global or local color standardization method. For example, it can be used to select the most similar reference images or to set the number of cluster used for local color transference.

Given an image I₀ and a set of reference standardized color images Iⱼ, j=1, 2, . . . , J the problem is to recolor I₀ such that the processed image is similar in color to the reference images, but its structural information is minimally altered. Or, stated more formally:

Problem: for a given

image I={I_{n,k}}, n=1, 2, . . . , N; k=1, 2, . . . , K;

a set of reference standardized color images Iⱼ, j=1, 2, . . . , J, and

a image colorfulness measure F(Colorₐₜ_{_}ₚᵢₓₑₗ(I_{n,k}))

a color differences C(Iⱼ, I₀, j=1, 2, . . . J), for example

$$C ( {I}_{j} , {I}_{0} , j = 1 , 2 , … J ) = \frac{1}{J} {\sum }_{j}^{ } [ {Color}_{colorfulness} ( {I}_{j} ) - {Color}_{colorfulness} ( {I}_{0} ) ] ,$$

where Color_{colorfulness}(.) is an image colorfulness measure

an image structural similarity measure D(I, I₀)

recolor the given image I
Such that the color differences

$$C ( {I}_{j} , {I}_{0} , j = 1 , 2 , … J ) {\to }_{j} is minimum , \\ or , \\ {C}_{ɛ} ( I , {I}_{j} ) = \{ \vert ‖ I - {I}_{j} ‖ \leq ɛ , for j = 1 , 2 , 3 , 4 … , J \}$$

### Subject to

D(I, I₀,)→max

Example of the image colorfulness measure C_{ε}(I, Iⱼ)
Note, that

1.

$${C}_{ɛ} ( I , {I}_{j} ) {\to }_{is minimum} {C}_{0}$$

a colorfulness measure comparing the input and the reference images must be minimized in order to ensure that images have similar color distribution. In the case of a set of several images are used for reference, the colorfulness condition become

$${C}_{ɛ} ( I , {I}_{j} ) = \{ \vert ‖ I - {I}_{j} ‖ \leq ɛ , for j = 1 , 2 , 3 , 4 … , N \} .$$

2.

$$D ( {I}_{p} , I ) {\to }_{is maximum} {D}_{0}$$

a image structural similarity measure comparing the original input image and the standardized image must be maximized in order to ensure that structural information such as edges is preserved after color processing.
Examples of the colorfulness measure include:

### Colorfulness Measure

### Example I

1. Generate the CIELUV and CIELAB

2. Calculate the Lightness (L*), two color axis (u*, v*) or (a*,b*)

3. Compute the color differences

4. Average color differences

New Colorfulness Measure

### Example II

Algorithm of Calculation of a New Colorfulness Measure

1. Convert a color {R,G,B} image I={I_{n,k}}=1, 2, . . . , N; k=1, 2, . . . , K into normalized r, g, b by using the following formulas:
a) r=R/R, r=G/G, b=B/B, 0≦r,g,b≦1; (for the classical subtraction case);
   where

$$R = \{ \begin{matrix}1 , & if unicolor \\ {R}_{0} = {max}_{n , k} [ {R}_{n , k} ] , & if image has texture\end{matrix} \\ G = \{ \begin{matrix}1 , & if unicolor \\ {G}_{0} = {max}_{n , k} [ {G}_{n , k} ] , & if image has texture\end{matrix} \\ B = \{ \begin{matrix}1 , & if unicolor \\ {B}_{0} = {max}_{n , k} [ {B}_{n , k} ] , & if image has texture\end{matrix}$$

b) r=(M−R)/(M−R)ₘₐₓ, r=(M−G)/(M−G)ₘₐₓ, b=(M−B)/(M−B)ₘₐₓ, 0≦r,g,b≦1; (for the PLIP subtraction case), where

$$M = {max}_{{R}_{0} , {G}_{0} , {B}_{0}} \{ {R}_{0} = {max}_{n , k} [ {R}_{n , k} ] , {G}_{0} = {max}_{n , k} [ {G}_{n , k} ] , {B}_{0} = {max}_{n , k} [ {B}_{n , k} ] \}$$

2. Calculate an image pixel I_{n,k} colorfulness measure

$${Color}_{at \_ pixe l} ( {I}_{n , k} ) = \{ \begin{matrix}0 if {( {r}_{n , k} • {g}_{n , k} )}^{2} + ( {r}_{n , k} • {b}_{n , k} ) ( {g}_{n , k} • {b}_{n , k} ) = 0 \\ cos [ \frac{α ( {r}_{n , k} • {g}_{n , k} ) + β ( {r}_{n , k} • {b}_{n , k} ) + γ ( {g}_{n , k} • {b}_{n , k} )}{\begin{matrix}2 [ {( {r}_{n , m} • {g}_{n , k} )}^{2} + {( {g}_{n , m} • {b}_{n , k} )}^{2} + \\ {2 ( {r}_{n , k} • {b}_{n , k} ) ( {g}_{n , k} • {b}_{n , k} ) ]}^{1 / λ}\end{matrix}} ]\end{matrix} \\ or , \\ {Color}_{at \_ pixe l} ( {I}_{n , k} ) = \{ \begin{matrix}0 if {( {r}_{n , k} • {g}_{n , k} )}^{2} + ( {r}_{n , k} • {b}_{n , k} ) ( {g}_{n , k} • {b}_{n , k} ) = 0 \\ \frac{α ( {r}_{n , k} • {g}_{n , k} ) + β ( {r}_{n , k} • {b}_{n , k} ) + γ ( {g}_{n , k} • {b}_{n , k} )}{\begin{matrix}2 [ {( {r}_{n , m} • {g}_{n , k} )}^{2} + {( {g}_{n , m} • {b}_{n , k} )}^{2} + \\ {2 ( {r}_{n , k} • {b}_{n , k} ) ( {g}_{n , k} • {b}_{n , k} ) ]}^{1 / λ}\end{matrix}}\end{matrix} \qquad Equation 7$$

where [symbol] is classical or parametric log subtraction operation and α, β, γ, λ are constants.
3. Calculate a function F(Colorₐₜ_{_}ₚᵢₓₑₗ(I_{n,m})) as the image colorfulness measure. For example, function F could be defined as:

a) Average based an image colorfulness measure:

$${Color}_{colorfulness} ( I ) = \frac{1}{( NK - O )} {\sum }_{n , k}^{ } {Color}_{at \_ pixel} ( {I}_{n , k} ) \qquad Equation 8$$

Where MK is the total number of pixels of M×K image I=[I_{n,k}] and where O is the number of pixels of M×K image, where (r_{n,k} [symbol] g_{n,k})²+(r_{n,k} [symbol] b_{n,k})(g_{n,k} [symbol] b_{n,k})=0

b) Entropy based an image colorfulness

$${Color}_{colorfulness} ( I ) = \{ \begin{matrix}0 {( {r}_{n , k} • {g}_{n , k} )}^{2} + ( {r}_{n , k} • {b}_{n , k} ) ( {g}_{n , k} • {b}_{n , k} ) = 0 \\ \frac{1}{( NK - O )} {\sum }_{n , k}^{ } \frac{{Color}_{at \_ pixel} ( {I}_{n , k} )}{{max}_{n , k} [ {Color}_{at \_ pixel} ( {I}_{n , k} ) ]} log [ \frac{{Color}_{at \_ pixel} ( {I}_{n , k} )}{{max}_{n , k} [ {Color}_{at \_ pixel} ( {I}_{n , k} ) ]} + 1 ]\end{matrix}$$

Where MK is the total number of pixels of M×K image I=[I_{n,k}] and where O is the number of pixels of M×K image, where (r_{n,k} [symbol] g_{n,k})²+(r_{n,k} [symbol] b_{n,k})(g_{n,k} [symbol] b_{n,k})=0

4. Compute the color differences
C(I, I₀)=Color_{colorfulness}(I)−Color_{colorfulness}(I₀)

### New Colorfulness Measure

### Example III

1. Compute the 3D color histogram for both the reference and input images.

2. Find the n more relevant colors in the reference and input images using scale space maxima detection in the 3D color histogram.

3. Find the average and entropy of the more relevant colors.

4. Compare the resulting colorfulness measure between reference and input image.

In addition to the aforementioned colorfulness measure, additional examples of measures that can be used for colorfulness quantitative analysis may be found in these references: A Othman and K. Martinez, Colour appearance descriptors for image browsing and retrieval, PROC. SPIE ELECTRONIC IMAGING 2008, 2008; G. Wyszecki and W. Stiles, Color science: Concepts and methods, quantitative data and formulae, New York, NY: John Wiley & Sons, 1982; C. Gao, K. Panetta and S. Agaian, Color image attribute and quality measurements, PROC. SPIE SENSING TECHNOLOGY+APPLICATIONS, 2014.;K. Panetta, C. Gao and S. Agaian, No reference Color Image Contrast and Quality Measures, IEEE TRANS. ON CONSUMER ELECTRONICS, vol. 59, no. 3, pp. 643-651, 2013.
For illustrative purposes, for the equations contained herein utilize the universal image quality index Q proposed by Wang and Bovik:

$$Q = \frac{{σ}_{xy}}{{σ}_{x} {σ}_{y}} \frac{2 \overline{x} \overline{y}}{{( \overline{x} )}^{2} + {( \overline{y} )}^{2}} \frac{2 {σ}_{x} {σ}_{y}}{{σ}_{x}^{2} + {σ}_{y}^{2}} \qquad Equation 8$$

Where σ_{xy} is the covariance of random variables representing gray levels in the original and processed image, σₓ is the standard deviation of the pixel intensities of the original image, σ_{y} is the standard deviation of the pixel intensities of the processed image, x̅ is the average of pixel intensities of the original image, and y̅ is the average of pixel intensities of the processed image. However, other similarity and quality measures can be employed. Examples of other image quality/similarity are as follows: 4-EGSSIM by S. Nercessian, S. Agaian and K. Panetta, “An image similarity measure using enhanced human visual system characteristics,” in Proc. SPIE Defense, Security, and Sensing, 2011 and S-EME by E. A. Silva, K. A. Panetta and S. S. Agaian, “Quantify similarity with measurement of enhancement by entropy,” in Proc. SPIE Mobile Multimedia/Image Processing for Military and Security Applications, 2007.

The following examples are included to demonstrate preferred embodiments of the invention. It should be appreciated by those of skill in the art that the techniques disclosed in the examples which follow represent techniques discovered by the inventor to function well in the practice of the invention, and thus can be considered to constitute preferred modes for its practice. However, those of skill in the art should, in light of the present disclosure, appreciate that many changes can be made in the specific embodiments which are disclosed and still obtain a like or similar result without departing from the spirit and scope of the invention.

### EXAMPLE I

### Color Standardization of Tissue Microarray Cores of Prostate Tissue

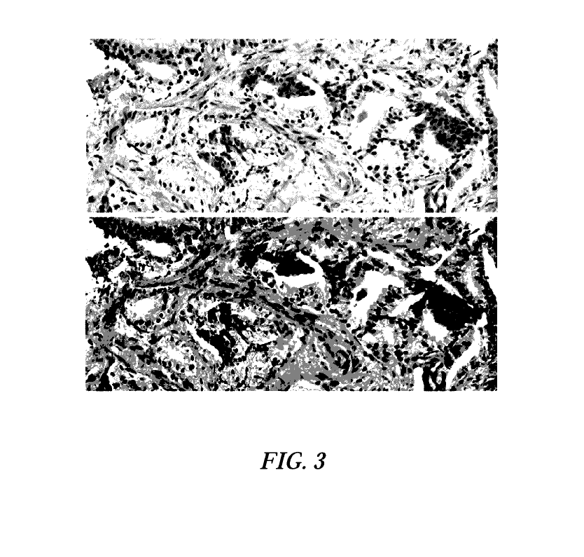

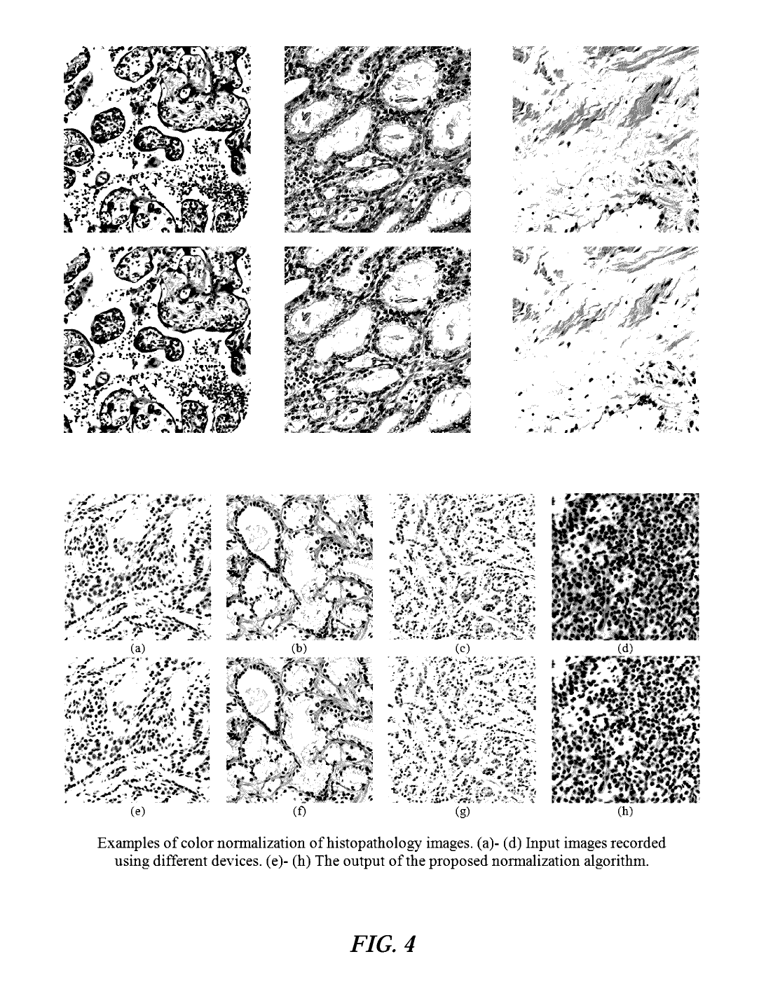

A batch of 360 H&E-stained tissue microarray cores of prostate tissue were standardized using the disclosed method. Local standardization of image pixels associated with broad prostate tissue structures (e.g., lumen, stroma, and epithelium) is carried out having as reference image the image shown in FIG. 3. The following steps were executed: (1) unsupervised color space feature extraction using scale space maxima detection for defining reference colors from a well-stained histopathology slide, (2) feature association between the resulting reference clusters and target clusters, and (3) weighted linear mapping of statistical moments (mean and standard deviation) from the reference image to target images. The standardized images are tested for assessing color consistency using normalized median intensity (NMI) (the lower the standard deviation of the NMI the better the color constancy) from segmented regions, and the resulting quality of the standardize image is evaluated using the universal image quality index (Q). Before standardization, the NMI standard deviation measure for the image set was 0.0310 and after standardization the resulting NMI standard deviation is 0.0097. Besides, the 95% confidence interval for the mean of the Q index is [0.9798, 0.9821], which indicates low distortion produced by the standardization algorithm. Examples of standardized images are shown in FIG. 4.

### EXAMPLE II

### Face Color Transference

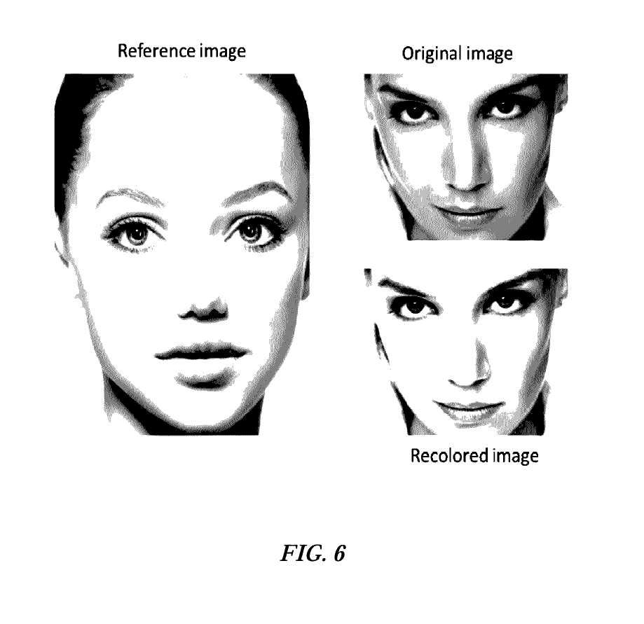

The example in FIG. 6 shows the results obtained using the fuzzy color transference in skin color lightening. The reference skin color centroid is detected by finding the most frequent color (3D histogram global maximum) within the skin area previously selected by the user. In the same way the centroid color are found for the target image. Since the only cluster in this example is the face, the mean and standard deviation of the face pixels are computer for each channel and for both reference and target image. Then, color transference is performed from the reference to the target image using the following equation:

$${I}_{i}^{norm , ch} ( x , y ) = {I}_{i}^{ch} ( x , y ) + {u}_{( x , y ) j} ( ( α - {μ}_{Ir , j}^{ch} ) + \frac{{σ}_{Ir , j}^{ch}}{{σ}_{Ii , j}^{ch}} ( {I}_{i}^{ch} ( x , y ) - ( α - {μ}_{Ii , j}^{ch} ) ) - {I}_{i}^{ch} ( x , y ) )$$

In this example, the color model using for color processing is lab color space. Once all transformation a performed in a per-pixel basis, image pixels in the target image are converted to RGB for visualization or storage.

### Additional Embodiments

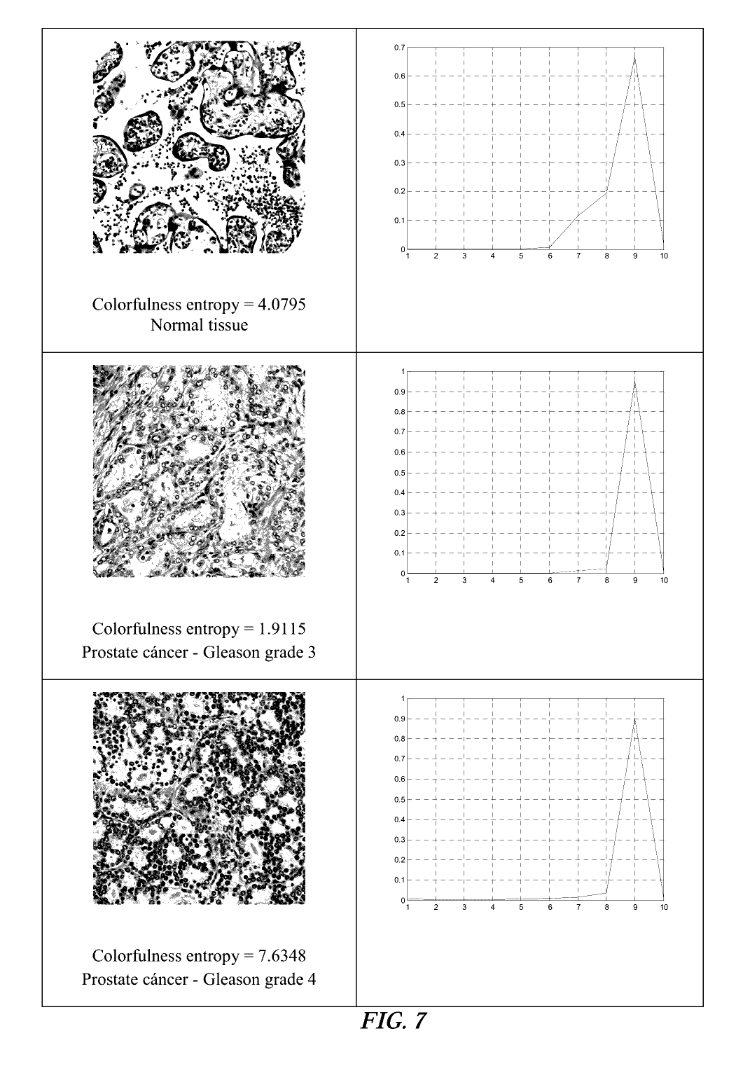

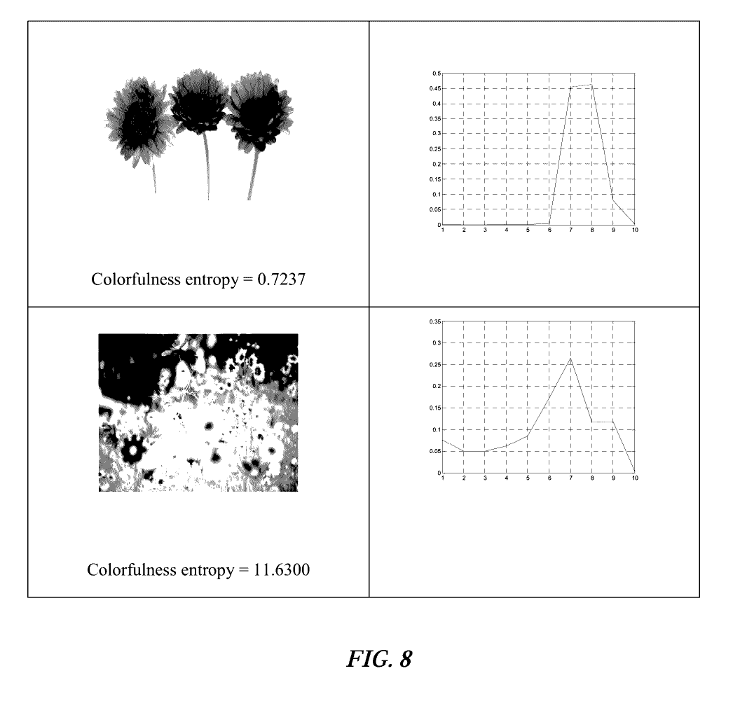

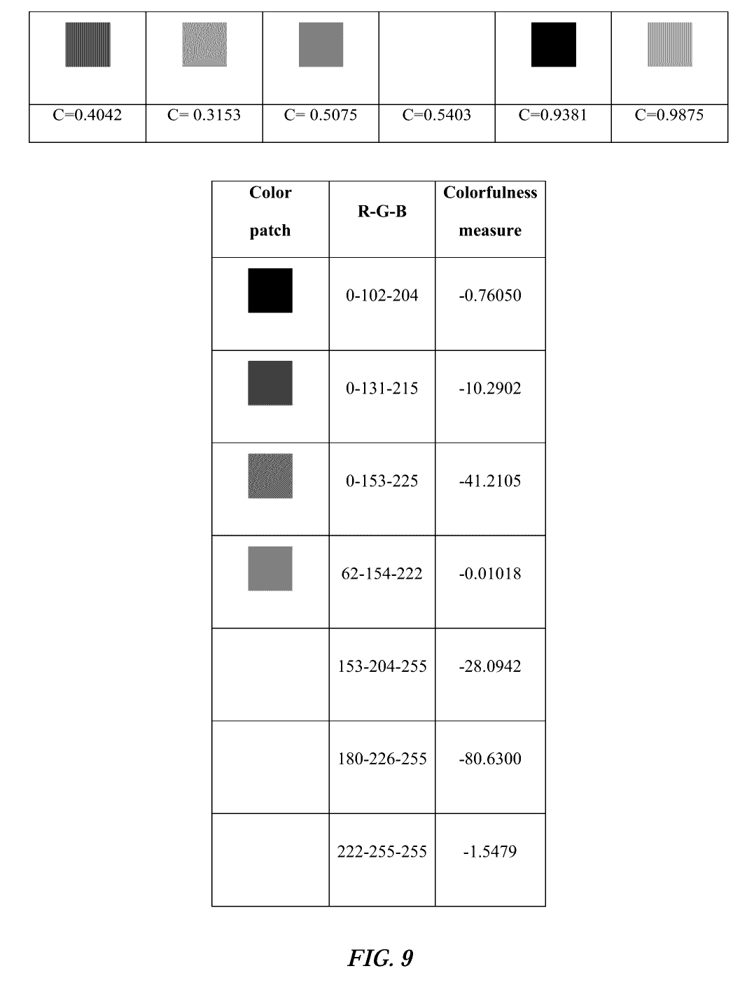

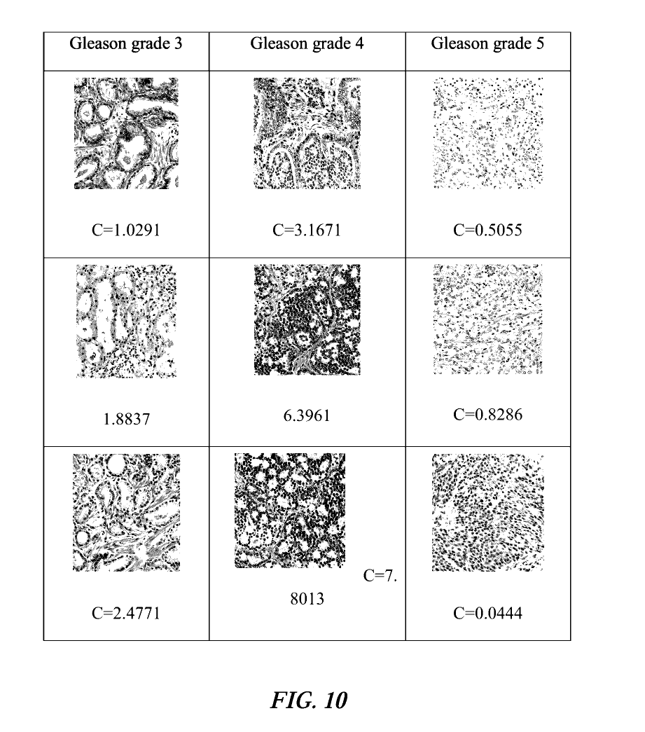

The present invention which is described hereinbefore with reference to flowchart and/or block diagram illustrations of methods, systems, devices, simulations, and computer program products in accordance with some embodiments of the invention has been illustrated in detail by using a computer system. For instance, the flowchart and/or block diagrams further illustrate exemplary operations of the computer systems and methods of FIG. 1 to FIG. 10. It is also conceivable that each block of the flowchart and/or block diagram illustrations, and combinations of blocks in the flowchart and/or block diagram illustrations, may be implemented by any computer program instructions and/or hardware. These computer program instructions may be provided to a processor of a general purpose computer, a microprocessor, a portable device such as cell phones, a special purpose computer or device, or other programmable data processing apparatus to produce a device, such that the instructions, which execute via the processor of the computer or other programmable data processing apparatus, create means for implementing the functions specified in the flowcharts and/or block diagrams or blocks. The computer program may also be supplied from a remote source embodied in a carrier medium such as an electronic signal, including a radio frequency carrier wave or an optical carrier wave.

In this patent, certain U.S. patents, U.S. patent applications, and other materials (e.g., articles) have been incorporated by reference. The text of such U.S. patents, U.S. patent applications, and other materials is, however, only incorporated by reference to the extent that no conflict exists between such text and the other statements and drawings set forth herein. In the event of such conflict, then any such conflicting text in such incorporated by reference U.S. patents, U.S. patent applications, and other materials is specifically not incorporated by reference in this patent.

Further modifications and alternative embodiments of various aspects of the invention will be apparent to those skilled in the art in view of this description. Accordingly, this description is to be construed as illustrative only and is for the purpose of teaching those skilled in the art the general manner of carrying out the invention. It is to be understood that the forms of the invention shown and described herein are to be taken as examples of embodiments.

Elements and materials may be substituted for those illustrated and described herein, parts and processes may be reversed, and certain features of the invention may be utilized independently, all as would be apparent to one skilled in the art after having the benefit of this description of the invention. Changes may be made in the elements described herein without departing from the spirit and scope of the invention as described in the following claims.

1. (canceled)

2. A method for standardizing the color and/or illumination of biopsy images acquired using an image capture device, the system comprising:
defining reference cluster colors from a well-stained histopathology reference slide or region, wherein the defining includes performing unsupervised color space feature extraction from the reference slide or region;
associating features between the reference clusters and target clusters of the biopsy images; and
performing linear mapping of statistics from the reference slide or region to the biopsy images.

3. The method of claim 2, wherein the image capture device is a scanner or camera-equipped microscope.

4. The method of claim 2, wherein the color feature extraction is performed using scale space maxima detection in the 3D color histogram.

5. The method of claim 4, wherein iterative 3D Gaussian or other smoothing filtering technique is used to produce n histogram scales of the 3D color histogram.

6. The method of claim 5, wherein maxima points of the 3D color histogram are detected at each histogram scale using a sliding box of size s×s×s, wherein the maxima points and are determined by detecting the most frequent color within the box, and wherein only the maxima that are present across all scales are considered feature colors or relevant colors.

7. The method of claim 2, wherein defining reference color clusters comprises grouping image pixels in broad tissue structures or regions by minimizing a distance metric between each image pixel and defined feature points.

8. The method of claim 7, wherein hard labels are assigned to each image pixel in the reference image and hard labels and fuzzy membership functions to each target image pixel.

9. The method of claim 8, wherein the local statistics corresponding to the group of pixels of the reference and target images are computed for each color channel independently using hard labels.

10. The method of claim 2, wherein the linear mapping of statistics is performed using a weighted linear function modulated by the fuzzy membership index of each pixel using the following equation:
$${i}_{p , new} = {\sum }_{fp }^{ } {u}_{p , fp} ( {μ}_{r , fp} + \frac{{σ}_{r , fp}}{{σ}_{t , reg}} ( {i}_{p} - {μ}_{t , reg} ) )$$

11. The method of claim 9, wherein the linear mapping of statistics is performed in the original RGB color space.

12. The method of claim 11, wherein if a color model transformation is performed for linear mapping of statistics, the target image(s) is converted back to the RGB model for display and storage.

13. A method, performed by a processing unit, for normalizing the color or illumination of biopsy images acquired using an image capture device, the method comprising:
performing color model conversion of the biopsy image and a reference image from a correlated to a decorrelated color space;
clustering image pixels in the reference image and the biopsy image using a fuzzy approach where the level of membership of a pixel to a given cluster is defined;
matching corresponding cluster of the biopsy image to the reference image;
and transferring local color statistics between respective clusters using the membership value of every pixel as a control parameter.

14. The method of claim 13, wherein clustering image pixels comprises using a fuzzy c-means clustering algorithm.

15. The method of claim 13, wherein the matching of corresponding clusters is performed by measuring the distances between clusters' centroids and the selected cluster is the one with minimum distance.

16. The method of claim 13, where the reference image is a well-stained biopsy image or a chart containing dominant colors of biopsy images.

17. The method of claim 13, wherein transferring local color statistics using a linear or non-linear transference function and wherein the influence of the transformation is controlled or modulated by the membership grade of each pixel to a given cluster.

18. The method of claim 13, wherein transferring local color statistics is applied pixel-wise and each channel is processed independently.

19. The method of claim 13, wherein a transformation to the correlated color model from the decorrelated color space is performed to obtain a normalized image.

20-38. (canceled)
